(19) United States
(12) Patent Application Publication
(10) Pub. No.: US 2017/0181231 A1
(43) Pub. Date: Jun. 22, 2017

(54) DEVICE FOR HEATING A FUNCTIONAL LAYER

(71) Applicant: HOMAG GMBH, Schopfloch (DE)

(72) Inventors: Domingo ROHDE, Kiel (DE); José Manuel CATALÁ-CIVERA, Valencia (ES)

(73) Assignee: HOMAG GMBH, Schopfloch (DE)

(21) Appl. No.: 15/325,487

(22) PCT Filed: Jun. 12, 2015
(86) PCT No.: PCT/EP2015/063171

§ 371 Date: Jan. 11, 2017

(30) Foreign Application Priority Data
Jul. 11, 2014 (DE) 10 2014 213 526.5

(51) Int. Cl. H05B 6/70; H05B 6/78; B27D 5/00; H05B 6/76

(52) U.S. Cl. CPC H05B 6/701; H05B 6/702; H05B 6/707; H05B 6/76; H05B 6/788; B27D 5/003

(57) ABSTRACT

The invention relates to a device for the heating a functional layer of coating material, such as a surface coating or an edge strip, in particular for applying the coating material onto an area of a workpiece, comprising a microwave source, an applicator and a microwave channel for supplying the microwave radiation generated in the microwave source to the applicator, wherein a microwave field is generable in the applicator on account of the supplied microwave radiation, wherein the applicator has at least one material channel, which passes through the applicator and through which the coating material can be fed such that the functional layer of the coating material is heated in the microwave field within the applicator.

### TECHNICAL FIELD

The invention relates to an apparatus for heating a functional layer of a coating material, such as a surface coating, or an edge band, in particular for applying the coating material onto an area of a workpiece.

### PRIOR ART

The prior art has disclosed the practice of applying coatings onto workpieces. Here, the workpieces are e.g., in particular, plate-shaped elements or elements produced in a three-dimensional manner from wood, wood materials, plastic or the like, as may be used, for example, for constructing, furniture or when producing components such as e.g. floor elements.

Here, the coatings are planar coatings for coating at least one planar broadside of the workpiece or so-called edge bands for coating at least one narrow side of the workpiece.

In so doing, it is known that the coatings consist of a surface layer and a functional layer, the functional layer serving to connect the coating to the workpiece. To this end, the functional layer should be activated for assuming its adhesive properties such that the joining process can be undertaken in a targeted manner.

The prior art has disclosed the activation of the functional layer by means of laser beams or by means of hot compressed air. The advantages of activation by means of laser beams may be found in the pinpoint application of the laser beam for activation with pinpoint control. However, the apparatus for activation by means of beams is disadvantageous in that the application tends only to exhibit its advantages for large numbers of items. It is also disadvantageous that the energy applied by the laser only acts on the surface or at a predefined low penetration depth between only approximately 1 μm and 100 μm and then needs to be forwarded into the depth of the functional layer by thermal conduction in order to obtain a uniform heating or activation of the functional layer.

The activation by way of hot compressed air is also known from the prior art. DE 10 2011 015 898 discloses an apparatus for generating hot compressed air which is made to flow onto an edge band in order to heat, and hence activate, the functional layer. In so doing, a significant amount of compressed air will be heated to high temperatures in order to heat or activate the functional layer while the latter passes through the apparatus. Such apparatuses consume significant amounts of energy to heat the large amounts of air required to over 400° C., with a large part of the energy being dissipated in the heat exchanger in a parasitic manner by e.g. thermal radiation or the like as a result of the design of the apparatus. Also, the high-volume hot air flow causes the surroundings or the apparatus to be exposed to high temperatures, which is accompanied by a significant outlay for climate control. Also, the apparatuses for activation by means of hot air exhibit high noise levels during the generation and outflow of the compressed hot air, which is disadvantageous for the operating staff of the apparatus and which is accompanied by significant outlay for noise damping. What was found when using hot air is that the upper layer of the functional layer is strongly liquefied at a hot air temperature of 400° C. to 500° C. on account of the high hot air temperatures and becomes partly detached from the functional layer by the strong airflow. These detached parts or the functional layer are recovered as contamination on the surrounding components and reduce the amount of adhesive available for adhesion. It is also disadvantageous that the energy applied by the hot air only acts on the surface and then needs to be forwarded by means of thermal conduction into the depth of the functional layer in order to obtain consistent heating or the functional layer to at temperature of substantially the process temperature or more. In the process, a strong temperature gradient arises between the surface of the functional layer and the back side of the functional layer which adjoins the decorative layer of the coating material.

### SUMMARY OF THE INVENTION, PROBLEM, SOLUTION, ADVANTAGES

It is an object of the invention to develop an apparatus for heating a functional layer of a coating material, such as, in particular, a surface coating or an edge band, in particular for applying the coating material onto an area of a workpiece, said apparatus having a simple and uncomplicated and compact embodiment and being expedient in respect of the energy efficiency and being operable in such a way that the functional layer of the coating material may be heated in a targeted manner.

This object is achieved by the features of claim 1.

One exemplary embodiment of the invention relates to an apparatus for heating a functional layer of a coating material, such as a surface coating or an edge band, in particular for applying the coating material onto an area of a workpiece, comprising a microwave source, an applicator and a microwave channel for supplying the microwave radiation generated in the microwave source to the applicator, wherein a microwave field is generable in the applicator on account of the supplied microwave radiation, wherein the applicator has at least one material channel which passes through the applicator and through which the coating material may be passed such that the functional layer of the coating material may be heated in the microwave field within the applicator. Uniform heating is achieved, even in deeper layers, by applying the microwave energy onto the coating material because the coating material is introduced into the microwave field in the applicator. As a result, uniform heating is quickly achieved, wherein the energy is made available in a very focused manner, reducing the overall energy consumption. This leads to an energy application which may easily be set and metered, which also leads to the temperature of the functional layer being able to be set very exactly and easily.

Here, the apparatus may be used both in a continuous installation for producing and processing workpieces and in a processing center as a stationary installation.

It is particularly advantageous if a plurality of applicators are provided. As a result, a plurality of coating materials may heated simultaneously when necessary, said coating materials being appliable parallel onto the same workpiece or onto different workpieces. Alternatively, a single coating material could also be heated differently at different positions by means of a plurality of applicators such that there may be a targeted adhesion to different base conditions.

It is also advantageous if at least one applicator or all applicators have an applicator segment or a plurality of applicator segments. As a result, the applicator may he subdivided into different regions or segments in which the microwave field may be set differently. This would permit specific adaptation of the in amount of heat to the specific requirements of the adhesion.

It is likewise advantageous if an applicator or an applicator segment has a material channel or a plurality of material channels. As a result, one coating material or a plurality of coating materials may be heated simultaneously.

In the case of particularly broad or planar coating materials, use may also be made of a plurality of applicators in order to heat regions of a coating material which are arranged next to one another.

It is also expedient if a stop for the microwave radiation is provided at at least one applicator and/or at at least one applicator segment. As a result, the microwave energy to be used or the microwave field may be set for the individual requirement.

It is also particularly advantageous if a modulation apparatus for setting the modulation of the microwave radiation is provided in at least one applicator and/or in at least one applicator segment. As a result, the resonant frequency or the applicator as a resonator may be adapted to the resonant frequency of the microwave source, e.g. of the magnetron. Here, the coating material to be heated, which is guided through the applicator, changes the microwave field or the resonant frequency of the applicator such that the modulation apparatus sets the building-up microwave field in such a way that the coating material may be heated in an ideal manner.

According to the invention, it is expedient in one exemplary embodiment if the at least one applicator or a group of applicators is fed with microwave radiation by a microwave source or by a plurality of microwave sources, with, in particular, each applicator or each group of applicators being fed by a dedicated microwave source.

It is also advantageous if the at least one applicator segment or a group of applicator segments is fed with microwave radiation a microwave source or by a plurality of microwave sources, with, in particular, each applicator segment or each group of applicator segments being fed by a dedicated microwave source. As a result, it is possible to specifically generate different conditions meeting the respective requirements of the respective coating material.

It is particularly advantageous if a plurality of applicators or a plurality of applicator segments are fed by a microwave source, wherein a splitting apparatus is provided for splitting the microwave radiation and/or the microwave energy to the respective applicators or applicator segments. The splitting apparatus divides the microwave radiation, particularly in respect of the power, among the respective applicators or among the respective applicator segments such that there may be a specific application of the microwave energy.

It is also advantageous for provision to be made of at least one microwave channel, in particular of one microwave channel per microwave source and/or one microwave channel per applicator and/or respectively one microwave channel per applicator segment. The microwave channel serves to forward the microwave radiation to the respectively involved applicators or applicator segments such that there may be targeted heating of the coating material.

It is particularly advantageous if the microwave channel is a waveguide and/or a coaxial cable. If provision is made of a plurality of applicator segments or applicators, it may be advantageous if the waveguide is subdivided into segments and the microwave radiation may be forwarded thus. The energy of the microwave energy may also be conducted from the microwave source to the applicator by means of coaxial cables. This is carried out using matched transitions, which are also referred to as “tapered coaxial transitions”. This is advantageous in that the applicator may easily be disassembled so that servicing work on the applicator may be simplified.

It is particularly advantageous the material channel extends through the at least one applicator and/or through the at least one applicator segment, the channel having an inlet opening and an outlet opening serving to admit the coating material into the material channel and to let it out again. The positioning in the microwave field of the applicator or of the applicator segment is defined by the material channel, yielding a defined energy influx. There may also be a separation by the material channel such that the coating material does not directly reach into the applicator because possible contamination is only removable with difficulties from the applicator.

In accordance with a further concept of the invention, it is also advantageous it the material channel has a circumferential wall which separates the material channel from the interior of the applicator or from the interior of the applicator segment. As a result, a complete separation may be undertaken, protecting the applicator. This also defines the path of the coating material through the applicator, which is conducive to the defined energy influx.

What is particularly advantageous here is if an apparatus is arranged at the inlet opening and/or at the outlet opening, said apparatus reducing or preventing an emergence of microwave radiation from the inlet opening or from the outlet opening. This may prevent the emerging microwave radiation or at least reduce this under the admissible thresholds.

It is particularly advantageous if the stop is arranged between the microwave source and the applicator or the applicator segment. As a result, it is possible to set the modulation of the microwave radiation, in particular for producing a standing and/or traveling wave of the microwave radiation in the applicator or in the applicator segment. As a result, the form of the resonance curve of the applicator becomes changeable. Here, the characteristic of the applicator shifts from a resonant apparatus to an apparatus with a traveling wave, depending on selection or the stop. As a result, the absorptive influences by the coating material onto the microwave field may be equalized or compensated.

It is also advantageous if the stop is an aperture, in particular an aperture in a metal wall. Hence, the metal wall may shield the microwave radiation, and so only microwave radiation passing through the aperture is forwarded to the applicators or applicator segments.

It is particularly advantageous if the aperture cross section of the aperture of the stop may be set in a variable manner. As result, the modulation of the microwave radiation may be adjusted according to requirements.

It is also advantageous if the stop has a metal element which may be set projecting into the aperture. This allows continuing setting of the effect of the stop, without adjusting the aperture.

Here, it is particularly advantageous for the effect of the stop if the metal element may be set in such a way that the penetration depth of the metal element into the opening may be set.

It is particularly advantageous if the metal element is a metal bolt or a different metal element. This may influence the microwave radiation particularly well.

It is also advantageous if the at least one material channel fixedly arranged in the applicator or in the applicator segment and the microwave field may be set in a variable manner in the applicator and/or in the applicator segment; this allows the microwave field to be set for the material properties of the coating material or for the dimensions of the coating material.

It is also advantageous if the at least one material channel may be set in a displaceable manner in the applicator or in the applicator segment. This also allows an adaptation to the coating material to be heated.

It is advantageous if the material channel and/or the microwave field may be set in such a way that a functional layer of the coating material may be arranged or passed through in a region of maximum electric field strength.

It is also advantageous if an applicator subdivides into a plurality of applicator segments, the applicator segments substantially having the same geometric dimensions. This allows an individual microwave energy level to be actuated in the applicator segments, which may meet the requirements of the coating material if the latter for example requires different heating levels over its height.

It is also advantageous if an applicator subdivides into a plurality of applicator segments, with at least some of the applicator segments differing in terms of height or width. This may also be advantageous if use is made of coating materials with different heights, such as edge bands with different heights.

In accordance with one inventive concept, it is advantageous if the applicator or the applicators or the applicator segment or the applicator segments are interchangeable. As a result, the respective preferred applicator or the applicators or the applicator segments which are preferably suitable for the coating material to be heated may be used.

Furthermore, it is advantageous the material channel consists of a material which is one of the following materials or comprises one of the following materials: PTFE, ceramic, glass, industrial glass and/or fused quartz. As a result, passivation of the surface may be achieved.

It is also advantageous if, on the inside, the material channel is coated by a material which is one of the following materials or comprises one of the following materials: PTFE, ceramic, glass, industrial glass and/or fused quartz.

Furthermore, it is expedient if, on the inside, the applicator or the applicators or the applicator segment or the applicator segments is/are coated by a material which is one of the following materials or comprises one of the following materials: PTFE, ceramic, glass, industrial glass and/or fused quartz.

In accordance with a further idea, it is advantageous if a modulation apparatus is arranged in the applicator and/or in one of the applicator segments or in a plurality of the applicator segments or in all applicator segments, said modulation apparatus, in particular, adapting the resonant frequency of the filled resonator to the frequency of the magnetron. The modulation apparatus influences the microwave field in such a way that, depending on the selected coating material, the latter is arranged in the region of the maximum of the field strength.

Furthermore, it is advantageous if provision is made of a temperature meter which facilitates monitoring of the temperature of the coating material in the material channel and/or at the entrance and/or exit of the material channel. Hence, the temperature of the coating material may be determined such that the energy to be applied, the microwave field and the distribution thereof may be adapted accordingly to the intended temperatures.

It is also advantageous if provision is made of a purging apparatus which facilitates the introduction or passing of a fluid, such as, in particular, a gas or air, into the material channel. As a result, there may be targeted cooling of the coating material on the surface side while the side of the functional layer may be purged.

Also, in particular, it is advantageous if provision is made of a guide apparatus which facilitates guidance of the coating material in the material channel. As result, the coating material may be guided through the microwave field in a targeted and safe manner.

Further advantageous configurations are described by the subsequent description of the figures and the dependent claims.

### BRIEF DESCRIPTION OF THE FIGURES OF THE DRAWING

Below, the invention will be explained in more detail on the basis of at least one exemplary embodiment using the figures of the drawing. In detail:

FIG. 1 shows a view of an apparatus according to the invention for heating a functional layer,

FIG. 2 shows a lateral view of an applicator,

FIG. 3 shows a view of an applicator from above,

FIG. 4 shows a view of an applicator from behind,

FIG. 5 shows a view of an applicator from in front,

FIG. 6 shows a lateral view of an applicator,

FIG. 7 shows a view of an applicator from above,

FIG. 8 shows a view of an applicator from behind,

FIG. 9 shows a view of an applicator from in front,

FIG. 10 shows a view of an applicator from above,

FIG. 11 shows a lateral view of an applicator,

FIG. 12 shows a lateral view of an applicator, and

FIG. 13 shows a view of an applicator from above.

### PREFERRED EL PEDIMENT OF THE INVENTION

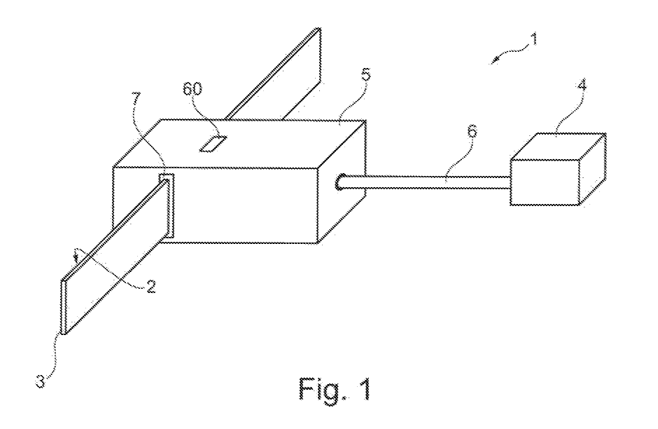

FIG. 1 shows a schematic illustration of an apparatus 1 according to the invention for heating a functional layer 2 of a coating material 3. Here, the phrase Keating a functional layer should also be understood to mean activating a functional layer. These terms are used equally or synonymously below. FIG. 1 shows the functional layer on one side of the coating material; however, it may likewise also be arranged on the other side of the coating material.

Here, the coating material is, in particular, an edge band which may be applied onto a workpiece on a narrow side or, in particular, a rather planar coating material, which may also be applied to a rather planar broad side of the workpiece.

Heating or activating the functional layer 2 serves to apply, and in particular permanently fasten, the coating material 3 onto an area of the workpiece. Here, the functional layer is activated in such a way that it forms or causes a type of adhesive, by means of which the coating material may be adhesively bonded onto the area of the workpiece.

The apparatus 1 comprises a microwave source 4 and an applicator 5, wherein the microwave radiation is transferred from the microwave source 4 to the applicator 5 by means of a microwave channel 6. The microwave channel 6, which is preferably embodied as a waveguide or as a coaxial cable, serves to supply the microwave radiation generated in the microwave source 4 to the applicator 5. As a result, a microwave field is generated in the applicator 5. through which the coating material 3 passes.

To this end, the applicator 5 has at least one material channel 7, which passes through the microwave field and through which the coating material is guided.

Here, the microwave field is embodied or actuatable in such a way that the functional layer of the coating material is heated or activated when the coating material passes through the microwave field.

Here, the coating material consists of at least two layers, of which one layer is the functional layer which is heated or activated, the at least one other layer, which is referred to as decorative layer below, not being heated where possible or not being heated as strongly.

The functional layer and the decorative layer may each also consist of a corresponding dedicated layer construction made of a plurality of individual layers. Thus, the functional layer and/or the decorative layer of the coating material may consist of at least one layer or of a plurality of layers.

The functional layer and the decorative layer each have a loss factor ε″_{eff}, which is considered to be the loss factor of the respective material of the functional layer and of the decorative layer. Here, the loss factor is the imaginary part of the complex relative permittivity of the respective material.

Here, the loss factor of the functional layer ε″_{eff}(FS) or the loss factor of the decorative ε″_{eff}(DS) is specified for frequencies (ISM) at 915 MHz, 2.45 GHz or 5.8 GHz.

The ratio R=ε″_{eff}(FS)/ε″_{eff}(DS) at one of the specified frequencies of 915 MHz, 2.45 GHz or 5.8 GHz defines the ratio of the loss factors.

Here, the specification of the coating material is such that R>1, preferably R>10 applies. This causes the functional layer FS to heat substantially more strongly than the decorative layer of the coating material, and so there is selective heating of the coating material, particularly when applying microwave applicators at the ISM frequencies of 915 MHz or 2.45 GHz or 5.8 GHz.

R is >1 and ε″_{eff}(FS) is >1, particularly when setting the applicator as an applicator with a traveling wave. In the case of a resonant applicator, R is >1 and ε″_{eff}(FS) is <50.

Here, microwave radiation with a power from 0.1 kW to approximately 50 kW is applied the applicator by the microwave source. Depending on the loss factor of the respective material, this results in heating of the respective material of the functional layer or of the decorative layer. Here, the functional layer heats more strongly than the decorative layer, and so the decorative layer is not heated or, at best, only heated slightly, while the functional layer is heated to the process temperature.

If use is made of a plurality of applicators, each applicator may be fed by the same microwave source or, alternatively, each applicator may be fed by a separate microwave source. It is also possible for groups of applicators or of applicator segments to be fed by one microwave source or by a plurality of microwave sources.

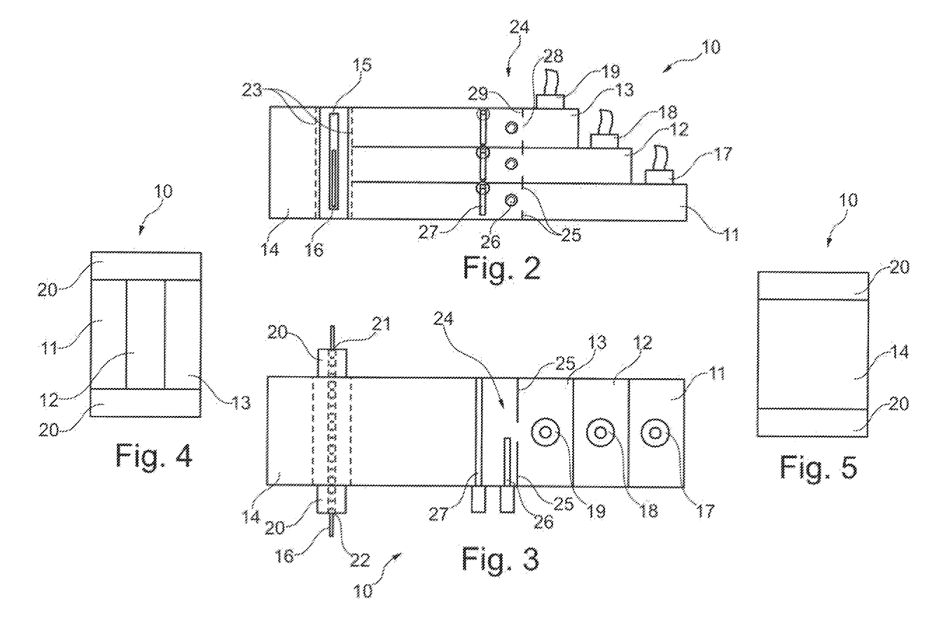

FIGS. 2 to 5 each show different views of an applicator 10 according to the invention in a first operating position. FIG. 2 shows the applicator in a side view, FIG. 3 in a plan view from above, FIG. 4 in a rear view and FIG. 5 in a front view.

The applicator 10 has three applicator segments 11, 12, 13, which are arranged one above the other. The applicator segments 11, 12, 13 are cavities, into which the microwave radiation is fed on the entrance side and which open into a chamber 14 in which the material channel 15 is provided, the latter forming a channel in order to be able to guide the coating material through the chamber 14. A traveling or standing wave of the microwave radiation forms in the chamber 14 and may heat or activate the coating material 16, depending on the loss factor, when the latter is passed through.

Here, the applicator segments 11, 12, 13 are arranged one above the other and formed in a stepped manner at the rear end thereof such that it is possible connect a microwave channel 17, 18, 19 on a top side of the respective applicator segment 11, 12, 13. Here, the microwave channel 17, 18, 19 is preferably a waveguide and/or a coaxial cable. If a waveguide is used, it may be advantageous for the waveguide to be subdivided into segments.

To the side of the material channel the latter is provided on both sides with an apparatus 20 as a choke, which attenuates the emergence of the microwave radiation or completely shields this. Here, the material channel 15 is embodied in such a way that it extends through the at least one applicator 10 and/or through the at least one applicator segment 11, 12, 13, the material channel 15 having an inlet opening 21 and an outlet opening 22 which serve to admit the coating material 16 into the material channel 15 and to let it out again. To this end, the material channel 15 has a circumferential wall 23, which separates the material channel 15 from the interior 14 of the applicator 10 or from the interior of the respective applicator segment 11, 12, 13.

FIGS. 2 to 5 to show an applicator 10 with three applicator segments 11 to 13. Alternatively, provision may also be made of a plurality of applicators or one or more applicators with one or more applicator segments. Here, it may be advantageous if at least one applicator 10 or all applicators have an applicator segment 11, 12, 13 or a plurality of applicator segments 11, 12, 13. Thus, the microwave radiation may be distributed to the respective applicators or to the respective applicator segments such that the heating of the coating material in the material channel may be adapted to the requirements.

Here, the distribution of the microwave radiation may be variable, for example over the height of the coating material. By way of example, the upper and/or the lower edge of the coating material may be heated stronger or less strongly than a central region.

The figures show an applicator with a material channel which leads through the applicator and through which the coating material is passed. According to the invention, a plurality of material channels may also be guided through the at least one applicator, which material channels may be arranged behind one another and/or over one another. As a result, a plurality or bands, strips or webs of coating material may be heated simultaneously. This may be advantageous in an apparatus in which a plurality of such heated coating materials are processed simultaneously. Thus, a plurality of workpieces may be coated simultaneously or one workpiece may be coated on a number of sides.

From FIGS. 2 or 3, it is possible further to identify that respectively one stop 24 is provided in the applicator or in the applicator segments 11, 12, 13. This stop serves to set the form of the resonance curve of the applicator or of the applicator segment. If the stop 24 is set to be larger, the characteristic of the applicator or of the applicator segment shifts from a resonant system with a standing wave to a system with a traveling wave. Here, the stop 24 preferably consists of a type of pinhole diaphragm 25 with a changeable passage cross section and/or it is made of a changeable metal element 26, like e.g. a metal pin, which serves to influence the microwave radiation in a targeted manner.

Both the pinhole diaphragm 25 and the metal element 26 preferably have an adjustable embodiment in order to be able to set the characteristic of the applicator 10 or of the applicator segment 11, 12, 13 for the respective requirements.

As shown in FIG. 2, the stop 24 is arranged between the microwave source and the applicator, or the applicator segment, or in the applicator or in the applicator segment. It is preferably disposed upstream of the modulation apparatus 27. However, alternatively, it could also be disposed downstream of the modulation apparatus.

Here, the stop 24 as a pinhole diaphragm 25 has an aperture 28, in particular an aperture 28 in a metal wall 29. Here, the aperture cross section of the aperture 28 of the stop may preferably be set in a variable manner.

The metal element 26 acting as a stop, which projects into the aperture of the applicator segment, may preferably also be set. Here, the degree of inward projection, i.e. the penetration depth of the metal element into the aperture, may be set.

The metal element 26 is preferably disposed downstream of the pinhole diaphragm 25. However, alternatively, it could also be disposed upstream of the pinhole diaphragm 25. Here, provision could be made of one metal element or, alternatively, a plurality of metal elements may also be provided. It or these may be arranged within and/or outside of the applicator.

According to the invention, the metal element is a metal bolt which projects into the applicator segment.

Furthermore, it can be seen in FIGS. 2 and 3 that a modulation apparatus 27 for setting the modulation of the microwave radiation is provided in at least one applicator 10 and/or in at least one applicator segment 11, 12, 13. Here, the modulation apparatus 27 is embodied as a type of flap which influences the microwave radiation in such a way that it adapts the resonant frequency of the resonator of the applicator or of the applicator segment 11, 12, 13 to the resonant frequency of the magnetron, i.e. the microwave source.

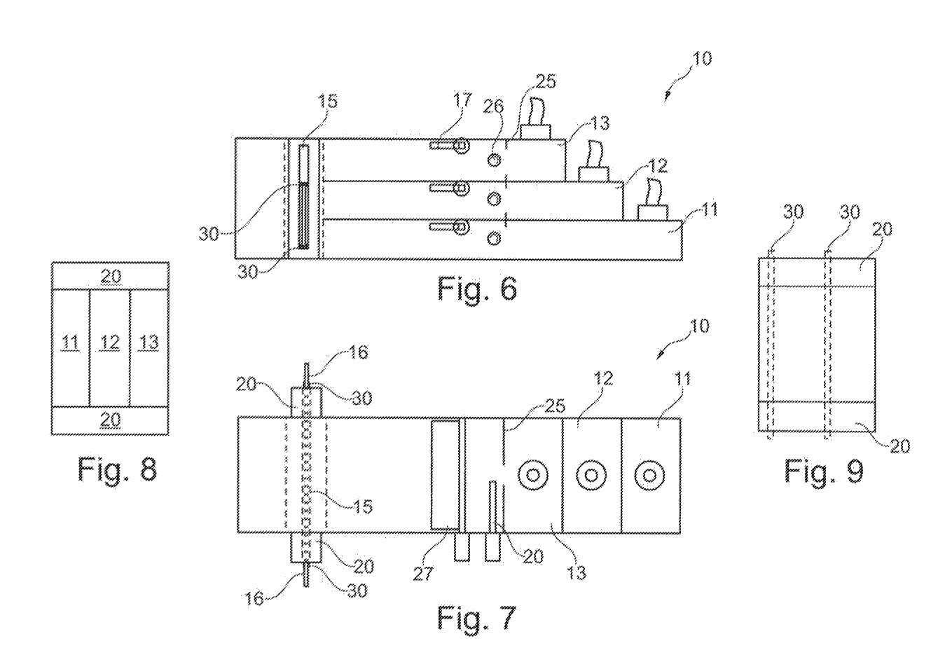

In FIGS. 2 and 3, the modulation apparatus 27 is embodied as a type of flap. This modulation apparatus 27 is set downward in FIGS. 2 and 3. In FIGS. 6 and 7, the modulation apparatus 27 is set folded upward.

In FIGS. 2 and 3, the at least one material channel 15 is arranged so as to re stationary in the applicator 10 or, alternatively, also in the applicator segment, wherein the microwave field may be set in a variable manner in the applicator 10 and/or in the applicator segment.

As an alternative thereto, the at least one material channel 15 may also be set in a displaceable manner in the applicator 10 or in the applicator segment in order to be able to set the coating material in the microwave field. Here, the material channel and/or the microwave field may be set in such a way that a functional layer of the coating material is arrangeable in a region of maximum electric field strength or may be passed through in this region.

Here, the coating material is guided through the material channel by means of a drive. Here, the drive may be attached the applicator or assigned thereto. Alternatively, the drive may also be a drive of an apparatus which applies the coating material onto the workpiece. Thus, the drive may be part or an edge gluing apparatus if, for example, the coating material is an edge which may be applied to the narrow side of a workpiece. Here, a press-on apparatus may also be disposed downstream of the applicator in order to apply the coating material onto the workpiece and press it thereon.

In FIGS. 2 and 3, the applicator segments 11, 12, 13 have an embodiment with the same height. Alternatively, an applicator 10 may also be subdivided into a plurality of applicator segments 11, 12, 13, wherein the applicator segments 11, 12, 13 may also have different geometric dimensions or heights. Here, an applicator may be subdivided into a plurality or applicator segments, wherein at least individual ones of the applicator segments may differ in terms of height and/or width. As a result, the energy influx into the coating material may be modulated as a function of height or width.

For modulating the heating or the activation of the coating material, it may also be advantageous if the applicator or the applicators or the applicator segment or the applicator segments are interchangeable. Thus, it is possible to use the applicators or the applicator segments with different heights or widths in order to be adapted to the coating material.

The material channel 15 is embodied as a continuous slit with a circumferential wall 23. Here, the material channel 15 is produced from a material which is at least one of the following materials or comprises one of the following materials: PTFE, ceramic, glass, industrial glass and/or fused quartz. Here, the material channel 15 may be produced, for example, from PTFE, such as Teflon, and inserted into the applicator 10 as a PTFE block.

On the inside too, the material channel 15 may be coated with a material which is one of the following materials or comprises one of the following materials: PTFE, ceramic, glass, industrial glass and/or fused quartz.

Moreover, the applicator 10 or the applicators or the applicator segment or the applicator segments 11, 12, 13 may, on the inside, be coated or filled with a material which is one of the following materials or comprises one of the following materials: PTFE, ceramic, glass, industrial glass and/or fused quartz.

FIGS. 6 and 9 show a guide apparatus 30 in the material slit 15, said guide apparatuses being embodied as guide rails and arranged at the bottom and top in the material slit 15. Here, the guide rails pass through the material slit 15 such that the coating material is guided on its path through the material slit. The two guide rails or, in general, the guide apparatus 30 may be set to the height or width of the coating material such that coating materials with different heights or widths, such as e.g. bands, may also be guided through the material slit. The guide apparatus serves guide the coating material and further is advantageous in that the heating is not as high in the region in which the coating material engages with the guiding apparatus as in a central region. What this achieves is that the edge region of the coating material is able to adhesively bond the functional layer more strongly. Here, the region in which the coating material engages into the guide apparatus is approximately 0.5 to 4 mm wide.

Here, the guide apparatus, like, in particular, the guide rails, may also be borne in a resilient manner in order to avoid jamming of the coating material.

Moreover, the guide apparatus, like the upper guide rail and/or the lower guide rail, may be connected to a purging apparatus and provided with channels in order to be purged by a purge medium such as air. As a result, the purge medium may be applied to the coating material in a lateral direction and/or directly from above or below in order to avoid overheating in the guide rail. To this end, the guide rails have channels, preferably in the lower surface and/or in the upper surface as well as in the lateral surfaces, through which the purge medium may be guided.

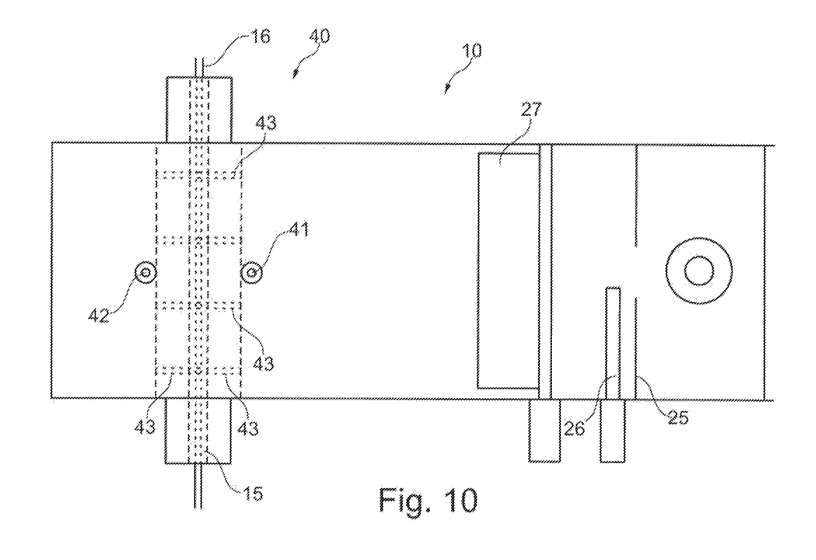

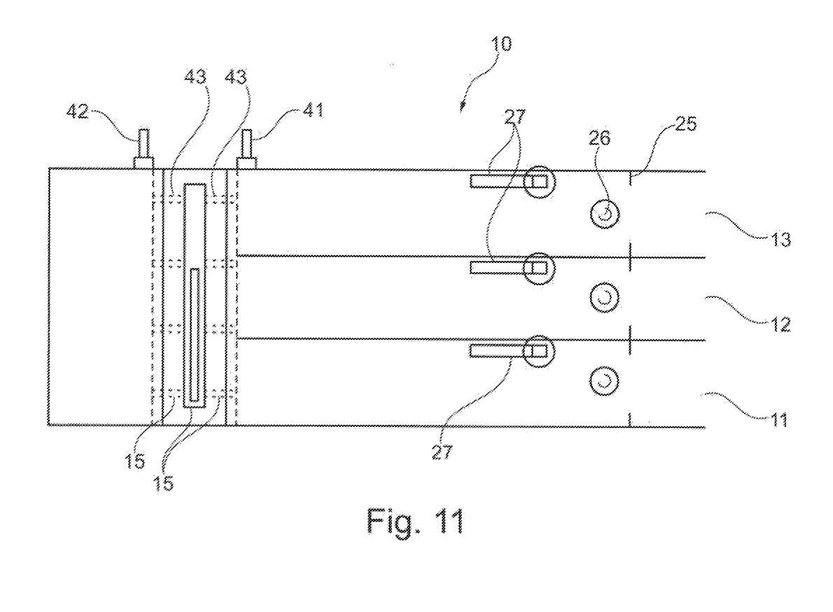

FIGS. 10 and 11 show an applicator 10 with a material slit 15 comprising a purging apparatus 40. The purging apparatus 40 comprise a first purge medium connector 41 and comprises a second purge medium connector 42, with the first purge medium connector 41 and the second purge medium connector serving to connect a purge medium. This purge medium, such as e.g. air, is guided from the purge medium connectors 41, 42 into channels 43 which spread apart and open into the material channel 15 in order to purge the material channel 15 and the coating material 16 in the material channel 15. The purging apparatus is an optional feature which may be used with the features of the other exemplary embodiments.

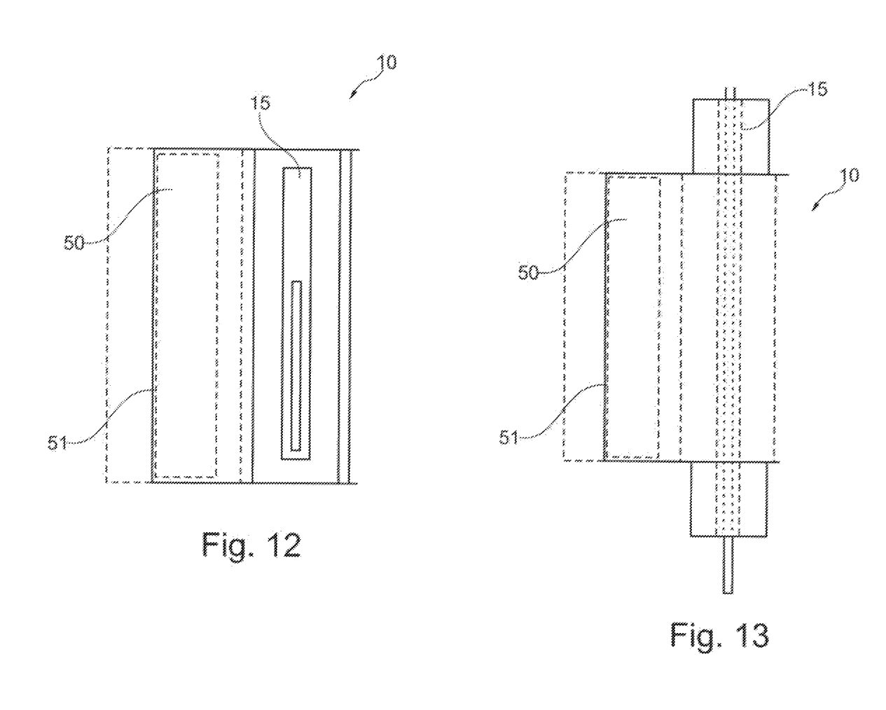

FIGS. 12 and 13 show one end region of the applicator 10, in which a filler 50 is provided to influence the dielectric properties of the resonator 51. As a result, the resonator 51 and the applicator 10, as a whole, may have a smaller embodiment since the filling changes the microwave field in such a way that a shorter installation length suffices in the case of a suitable filling 50. The filling is an optional feature which may be used with the features of the other exemplary embodiments.

Provision is particularly preferably made of a temperature measuring apparatus 60 which facilitates monitoring of the temperature of the coating material 16 in the material channel 15 and/or at the entrance and/or at the exit of the material channel 15. As a result, there may be feedback for controlling the microwave energy and/or the resonant frequency of the applicator or the shape of the microwave field. To this end, a plurality of temperature sensors which detect the temperature of the coating material may be arranged. In this case, the number of temperature sensors may be 1 to 20 or more. Here, it is particularly advantageous if a continuous measurement of the temperature of the functional layer of the coating material is undertaken.

As a result, for example, there may be open-loop or closed-loop control of the temperature of the functional layer as a function of the output power of the microwave source.

In so doing, the setpoint value of the temperature of the functional layer may, for example, be kept constant over the length of the edge band. Alternatively, it is expedient if the setpoint value of the temperature of the coating material may be varied, wherein the variation may be undertaken in accordance with a user-specific profile.

The apparatus according to the invention serves to heat or activate a coating material. Here, the heating process by means of the microwave applicator may be combined with other heating apparatuses or heating methods. Here, these further heating apparatuses may be used for preheating and/or for reaching or holding the process temperature of the functional layer. Here, the temperature profile, to be reached, of the coating material in the process direction and perpendicular to the process direction may be reached by combining the heating profiles of the individual heating apparatuses. For preheating purposes, the heating apparatus is arranged upstream of the microwave heating apparatus in relation to the direction of advance of the coating material. To this end, the following heating apparatuses are suitable: direct heating of the functional layer by way of mechanical contact with heated mechanical components, hot air, IR, VIS or UV lamps, LED or laser apparatuses or ultrasound. In order to reach or hold the process temperature or the functional layer, the additional heating apparatus is disposed downstream of the microwave heating apparatus in relation to the direction of advance of the coating material. To this end, the following energy sources are advantageous: hot air, IR, VIS or UV lamps, LED or laser apparatuses or ultrasound.

The exhibited applicators may be used individually or groups. Moreover, the applicators may have individual applicator segments or groups thereof. Here, the applicator segments of one applicator may differ in terms of height in order to be able to achieve an ideal heating of coating materials of different heights, e.g. as bands. The number of applicators preferably lies between 1 and 20 or more. The number of applicator segments preferably lies between 1 and 20 or more.

1. An apparatus for heating a functional layer of a coating material, such as a surface coating or an edge band, in particular for applying the coating material onto an area of a workpiece, comprising a microwave source, an applicator and a microwave channel for supplying the microwave radiation generated in the microwave source to the applicator, wherein a microwave field is generable in the applicator on account of the supplied microwave radiation, wherein the applicator has at least one material channel which passes through the applicator and through which the coating material may be passed such that the functional layer of the coating material is heated in the microwave field within the applicator.

2. The apparatus as claimed in claim 1, wherein a plurality of applicators are provided.

3. The apparatus as claimed in claim 1, wherein at least one applicator or all applicators have an applicator segment or a plurality of applicator segments.

4. The apparatus as claimed in claim 1, wherein an applicator or an applicator segment has a material channel or a plurality of material channels.

5. An apparatus, in particular as claimed in claim 1, wherein a stop for the microwave radiation is provided at at least one applicator and/or at at least one applicator segment.

6. An apparatus, in particular as claimed in claim 1, wherein a modulation apparatus for setting the modulation of the microwave radiation is provided in at least one applicator and/or in at least one applicator segment.

7. The apparatus as claimed in claim 6, wherein the at least one modulation apparatus serves to set the resonant frequency of the applicator or of the applicator segment or of the applicator segments.

8. The apparatus as claimed in claim 1, wherein the at least one applicator or a group of applicators is fed with microwave radiation by a microwave source or by a plurality of microwave sources, with, in particular, each applicator or each group of applicators being fed by a dedicated microwave source.

9. The apparatus as claimed in claim 1, wherein the at least one applicator segment or a group of applicator segments is fed with microwave radiation by a microwave source or by a plurality of microwave sources, with, in particular, each applicator segment or each group of applicator segments being fed by a dedicated microwave source.

10. An apparatus, in particular according to claim 1, wherein a plurality of applicators or a plurality of applicator segments are fed by a microwave source, wherein a splitting apparatus is provided for splitting the microwave radiation and/or the microwave energy to the respective applicators or applicator segments.

11. The apparatus as claimed in claim 1, wherein provision is made of at least one microwave channel, in particular of one microwave channel per microwave source and/or one microwave channel per applicator and/or respectively one microwave channel per applicator segment.

12. The apparatus as claimed in claim 1, wherein the microwave channel is a waveguide and/or a coaxial cable.

13. The apparatus as claimed in claim 1, wherein the waveguide is subdivided into segments.

14. An apparatus, in particular as claimed in claim 1, wherein the material channel extends through the at least one applicator and/or through the at least one applicator segment, the channel having an inlet opening and an outlet opening serving to admit the coating material into the material channel and to let it out again.

15. The apparatus as claimed in claim 14, wherein the material channel has a circumferential wall which separates the material channel from the interior of the applicator or from the interior of the applicator segment.

16. The apparatus as claimed in claim 1, wherein an apparatus is arranged at the inlet opening and/or at the outlet opening, said apparatus reducing or preventing an emergence of microwave radiation from the inlet opening or from the outlet opening.

17. The apparatus as claimed in claim 1, wherein the stop is arranged between the microwave source and the applicator or the applicator segment, or in the applicator or in the applicator segment.

18. The apparatus as claimed in claim 1, wherein the stop is an aperture, in particular an aperture in a metal wall.

19. The apparatus as claimed in claim 1, wherein the aperture cross section of the aperture of the stop may be set in a variable manner.

20. The apparatus as claimed in claim 1, wherein the stop has a metal element which may be set projecting into the aperture.

21. The apparatus as claimed in claim 20, wherein the metal element may be set in such a way that the penetration depth of the metal element into the opening may be set.

22. The apparatus as claimed in claim 20, wherein the metal element is a metal bolt.

23. The apparatus as claimed in claim 1, wherein the at least one material channel is fixedly arranged in the applicator or in the applicator segment, and the microwave field may be set in a variable manner in the applicator and/or in the applicator segment.

24. The apparatus as claimed in claim 1, wherein the at least one material channel may be set in a displaceable manner in the applicator or in the applicator segment.

25. The apparatus as claimed in claim 1, wherein the material channel and/or the microwave field may be set in such a way that a functional layer of the coating material may be arranged or passed through in a region of maximum electric field strength.

26. The apparatus as claimed in claim 1, wherein an applicator subdivides into a plurality of applicator segments, the applicator segments substantially having the same geometric dimensions.

27. The apparatus as claimed in claim 1, wherein an applicator subdivides into a plurality of applicator segments, with at least some of the applicator segments differing in terms of height or width.

28. The apparatus as claimed in claim 1, wherein the applicator or the applicators or the applicator segment or the applicator segments are interchangeable.

29. The apparatus as claimed in claim 1, wherein the material channel consists of a material which is one of the following materials or comprises one of the following materials: PTFE, ceramic, glass, industrial glass and/or fused quartz.

30. The apparatus as claimed in claim 1, wherein, on the inside, the material channel is coated by a material which is one of the following materials or comprises one of the following materials: PTFE, ceramic, glass, industrial glass and/or fused quartz.

31. The apparatus as claimed in claim 1, wherein, on the inside, the applicator or the applicators or the applicator segment or the applicator segments is/are coated by, or filled with, a material which is one of the following materials or comprises one of the following materials: PTFE, ceramic, glass, industrial glass and/or fused quartz.

32. The apparatus as claimed in claim 1, wherein a modulation apparatus is arranged in the applicator and/or in one of the applicator segments or in a plurality of the applicator segments or in all applicator segments, said modulation apparatus, in particular, influencing the resonant frequency of the applicator or the applicator segment depending on the coating material and/or the physical properties and/or the dimensions of the coating material to be treated.

33. An apparatus, in particular according to claim 1, wherein provision is made of a temperature meter which facilitates monitoring of the temperature of the coating material in the material channel and/or at the entrance and/or exit of the material channel.

34. An apparatus, in particular according to claim 1, wherein provision is made of a purging apparatus which facilitates the introduction or passing of a fluid, such as, in particular, a gas or air, into the material channel.

35. An apparatus, in particular according to claim 1, wherein provision is made of a guide apparatus which facilitates guidance of the coating material in the material channel.
